(19) United States
(12) Patent Application Publication
(10) Pub. No.: US 2026/0124684 A1
(43) Pub. Date: May 7, 2026

(54) Device for handling a clamping ram

(71) Applicant: ADELBERT HAAS GMBH, Trossingen (DE)

(72) Inventor: Timo ZEPF, Seitingen-Oberflacht (DE)

(21) Appl. No.: 19/439,751

(22) Filed: Jan. 5, 2026

Related U.S. Application Data
(62) Division of application No. 19/174,586, filed on Apr. 9, 2025.

(30) Foreign Application Priority Data
Apr. 11, 2024 (DE) 102024110181.4

(51) Int. Cl. B23B 31/28

(52) U.S. Cl. CPC B23B 31/28; B23B 2260/10

(57) ABSTRACT

The invention relates to a device (10) for handling a clamping ram (100) which has a shaft (110) with a longitudinal axis (L) and a collar (112), with an arm (20) that can be moved in at least one spatial direction (X) with a first end (20a) on which a fastening unit (30) for fastening the clamping ram (100) is arranged, wherein the fastening unit (20) comprises a magnetic or magnetizable contact element (31) for magnetically fastening the clamping ram (100), as well as a method for changing a tool or a workpiece (300) on a machine tool (200) making use of such a device (10).

Machine tools are being operated in an increasingly automated manner. This is, in particular, accompanied by the fact that the tool change is also partially or fully automated during operation of such a machine tool. It is common practice to connect the various tools to a spindle, an axis of rotation or another indexing head of the machine tool by means of a tool holder.

There are also cases in which the workpiece to be machined is coupled with the spindle, the axis of rotation or the other indexing head of the machine tool. To illustrate this, the term “tool or workpiece holder” is used in the following, even if every tool holder is actually also a workpiece holder or respectively becomes a workpiece holder if the clamping means, in which the tool is held as intended in a tool holder, is used to hold a workpiece.

It is known to fasten tools or workpieces which have an axial hole in the tool or workpiece holder by means of a clamping ram, which in particular comprises an elongate cylindrical shaft with a collar at one end, which in particular forms a radial thickening. For this purpose, the clamping ram is guided through the hole and the cylindrical shaft of the clamping ram is gripped in a chuck of the tool or workpiece holder and drawn in in the axial direction to such an extent that the tool or workpiece bears against a front side of the tool or workpiece holder and is held clamped between the front side of the tool or workpiece holder and the collar of the clamping ram.

A change of the tool or workpiece is time-consuming: either the tool or workpiece must be held with a separate handling unit, while the clamping ram must be pulled out of the hole of the tool or workpiece with another handling unit, for which purpose a projection must be arranged on the side of the collar facing away from the shaft, on which projection the handling unit can grip the clamping ram. Alternatively, in order to reinsert another tool or workpiece together with another clamping ram, the tool or workpiece must be pulled out of the tool or workpiece holder together with the clamping ram using a handling unit, which on the one hand increases the feed paths and the number of handling steps, and on the other hand requires a larger number of clamping rams to be kept at the ready.

The task of the invention is therefore to provide a device for handling a clamping ram, with which a simplified change of a tool or workpiece on a machine tool can be made possible.

The task is solved according to the invention by a device for handling a clamping ram with the features of patent claim 1, by a set comprising a device for handling a clamping ram and a machine tool with the features of patent claim 10 as well as a method for changing a tool or a workpiece on a machine tool with the features of patent claim 12.

Advantageous embodiments and further developments of the invention are given in the dependent claims.

The device according to the invention for handling a clamping ram which has a shaft with a longitudinal axis and a collar, with an arm that can be moved in at least one spatial direction with a first end on which a fastening unit for fastening the clamping ram is arranged, characterized in that the fastening unit comprises a magnetic or magnetizable contact element for magnetically fastening the clamping ram. Since the clamping ram is usually made of metal, it is possible to attach the clamping ram to the fastening unit much more quickly with the aid of a magnetic or magnetizable contact element than, for example, with a gripping element. In addition, a magnetic or magnetizable contact element enables fastening to the clamping ram not only from a radial direction, but also in the axial direction of the clamping ram, which has advantages when handling the clamping ram.

According to a preferred embodiment, the contact element comprises a permanent magnet, which can enable an attachment without additional components, in particular without the need for a supply of power, simply by bringing the contact element closer to the clamping ram.

According to a further advantageous embodiment, the contact element comprises an electromagnet. This allows the fastening unit to be selectively switched on and off, which may be desirable depending on the application.

Advantageously, the contact element is arranged on the front side of the arm. This allows a spatially favorable arrangement to be achieved, which can be particularly advantageous when the contact element approaches the clamping ram in an axial direction or, in other words, in a direction parallel to the longitudinal axis of the clamping ram.

Preferably, the contact element comprises an alignment tip. This alignment tip can determine the positioning of the clamping ram relative to the contact element when the contact element is in contact with the clamping ram, in particular, if the clamping ram has a corresponding recess, in particular, on its front side, into which the alignment tip inserts itself when the contact element is in contact with the clamping ram. Such an alignment tip can also improve the resistance to tilting and prevent lateral displacement or slipping.

A particularly preferred further development of the invention provides that the contact element comprises an ejector pin which is designed to be movable relative to the contact element. Such an ejector pin makes it possible to release the magnetic fastening between the contact element and the clamping ram in a simple manner by moving the ejector pin relative to the contact element, this in order to remove the clamping ram from the contact element.

Preferably, the ejector pin is arranged spring-loaded in a retracted position and can be moved into an extended position against the spring force, preferably by means of a pneumatic unit. The use of a configuration of this type allows a selective release of the fastening between the clamping ram and contact element, whereas the ejector pin otherwise does not influence the fastening process, inasmuch as it is usually in a retracted position.

According to a preferred embodiment, the alignment tip is arranged on the ejector pin. This allows a particularly compact design to be achieved.

It is particularly preferred that the arm is movable in precisely one spatial direction, wherein the longitudinal axis of one clamping ram attached to the fastening unit is arranged parallel to this spatial direction. This means that the movement required when changing a tool or workpiece can be kept to a minimum.

A device as described here above is, in particular, part of a set further comprising a machine tool with at least one spindle, an axis of rotation or an indexing head, on which a tool or workpiece holder is arranged, wherein the device is arranged relative to the machine tool in such a way that a rotational axis of the spindle, of the axis of rotation or of the indexing head is arranged parallel to the longitudinal axis of a clamping ram attached to the fastening unit as well as parallel to the at least one spatial direction in which the arm is movable. Preferably, the arm is movable in precisely one spatial direction, so that one substantially linear back and forth movement takes place. With a set of this type, the movement required to change a tool or workpiece can be kept to a minimum and a change can be made quickly and effectively.

A method according to the invention for changing a tool or a workpiece on a machine tool, wherein the tool or the workpiece is held under tension in a tool or workpiece holder by means of a clamping ram, comprising the following steps:
gripping the tool or workpiece held under tension in the tool or workpiece holder with a first handling unit,
moving of the arm of a device for handling a clamping ram according to one of claims 1 through 9 in a spatial direction until the contact element of the fastening unit bears against the clamping ram,
pulling out the clamping ram by moving the arm back in the spatial direction until the clamping ram is completely pulled out of the hole of the tool or workpiece,
removing the tool or workpiece by means of the first handling unit,
supplying of a new tool or workpiece,
retracting the clamping ram by moving the arm with the clamping ram in the spatial direction until the collar of the clamping ram bears against the new tool or workpiece.

By means of such a method, a change of a tool or workpiece can take place by simply pulling out the clamping ram using the device for handling the clamping ram and exchanging the tool or workpiece using a handling unit. The magnetic or magnetizable contact element thereby enables the clamping ram to be attached quickly and easily, in particular, in the axial direction of the clamping ram, which simplifies movement sequences.

Preferably, the arm is moved in precisely one spatial direction. The amount of movement required can thereby be minimized, which can enable a quick change of the tool or workpiece.

Preferably, the supplying of the new tool or workpiece takes place using a second handling unit, which can significantly reduce the time required for the change compared to using just one handling unit.

Advantageously, before the clamping ram is pulled out, the fastening of the clamping ram in the tool or workpiece holder is released and, after the clamping ram is retracted, the clamping ram is refastened in the tool or workpiece holder.

According to an advantageous further development, an ejector pin of the device is advanced after the clamping ram has been retracted in order to release the clamping ram from the device. If the device is thereinafter removed from the machine tool, the clamping ram remains in the tool or workpiece holder. The ejector pin can also thereby be pushed forward so far that the collar of the clamping ram is pressed into the counterbore of the tool or workpiece hole.

The invention is explained in detail with reference to the following figures. Wherein,

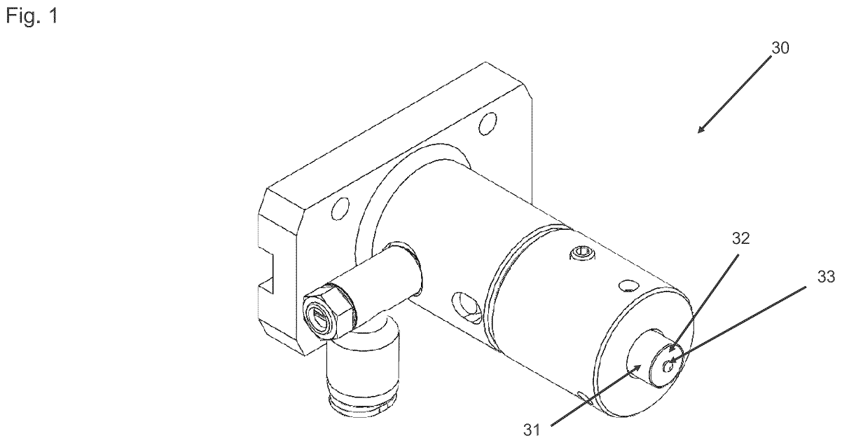

FIG. 1 shows a perspective view of a part of an embodiment example of a device according to the invention for handling a clamping ram with a fastening unit with a contact element and an ejector pin,

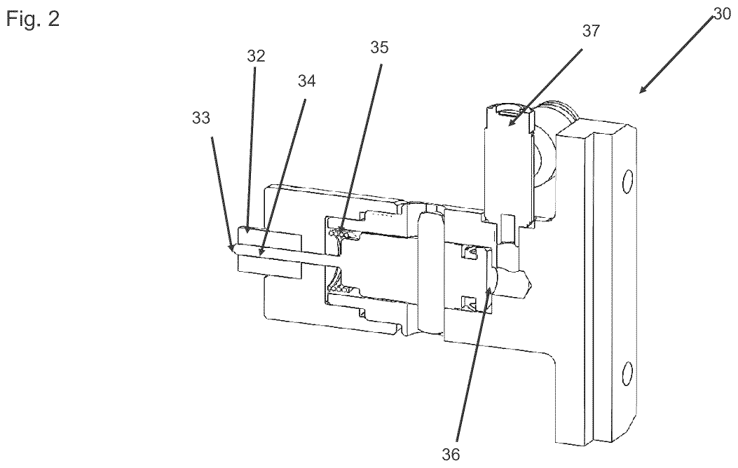

FIG. 2 shows a partially sectioned perspective view of the device according to FIG. 1,

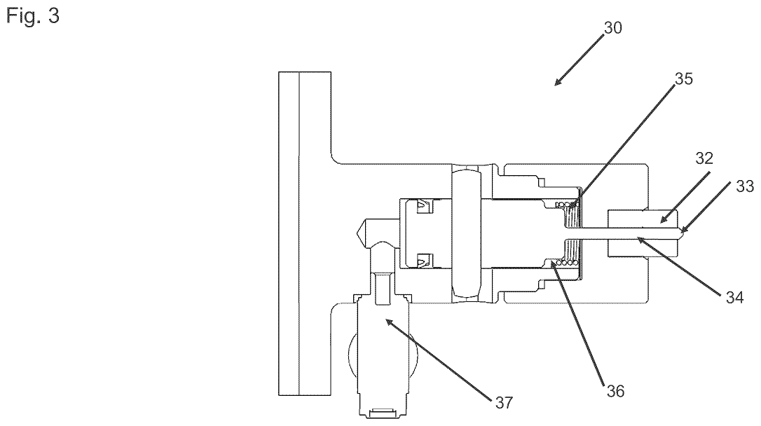

FIG. 3 shows a longitudinal cross-section through the part of the device according to FIG. 1,

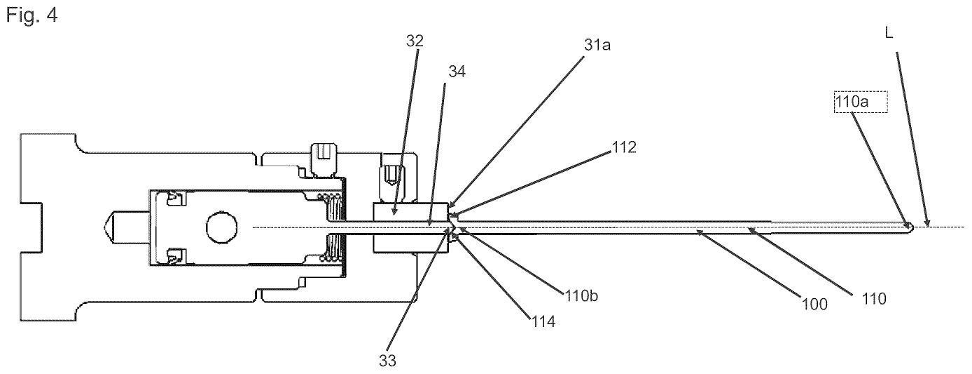

FIG. 4 shows a further longitudinal cross-section through the part of the device according to FIG. 1 with a clamping ram attached to the device,

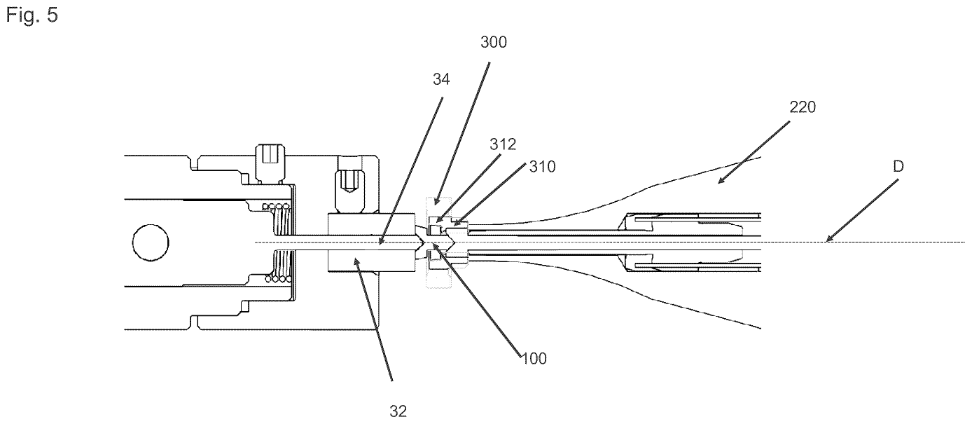

FIG. 5 shows a longitudinal cross-section through the part of the device according to FIG. 1 with a clamping ram attached to the device, which clamping ram fixes a tool or workpiece to a tool or workpiece holder,

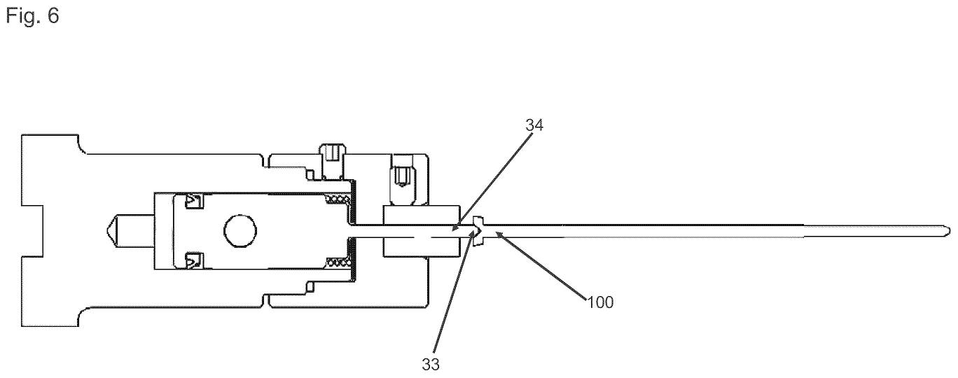

FIG. 6 shows the view according to FIG. 4, wherein the ejector pin is extended,

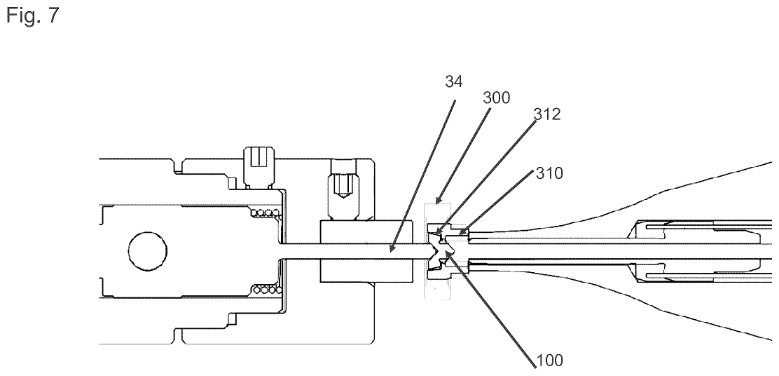

FIG. 7 shows the view according to FIG. 5, wherein the ejector pin is extended,

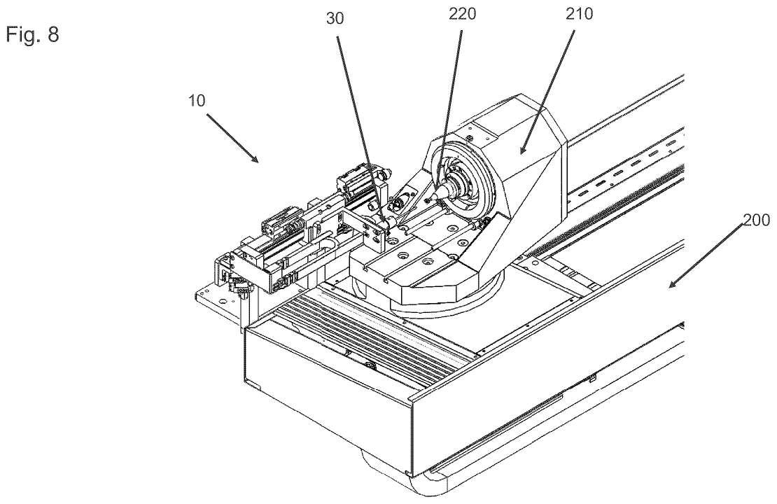

FIG. 8 shows a perspective view of a machine tool and the part of the device according to FIG. 1 with a clamping ram arranged thereon as well as with a movable arm,

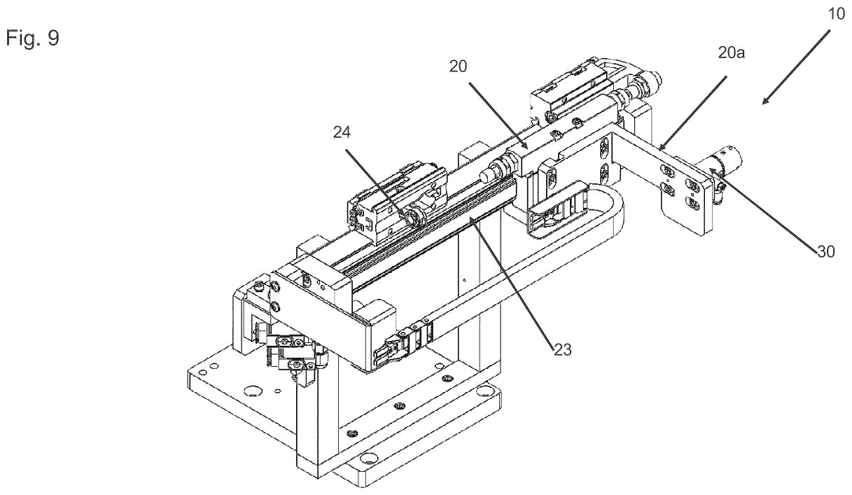

FIG. 9 shows a perspective view of the device for handling the clamping ram from FIG. 8 in an advanced position,

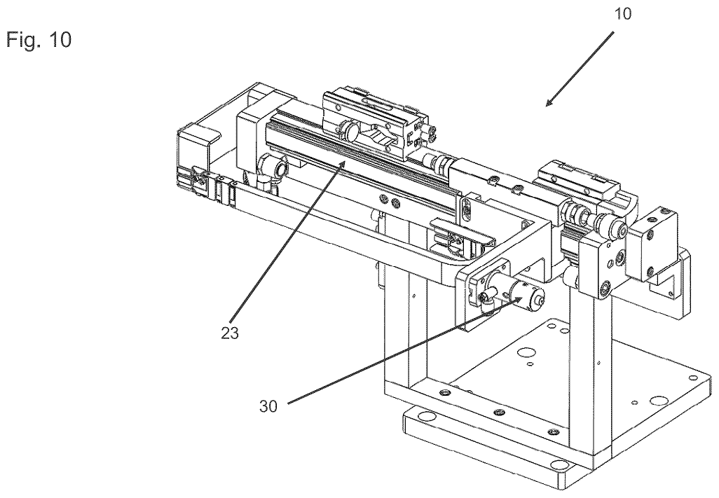

FIG. 10 shows a further perspective view of the device for handling the clamping ram from FIG. 8 in a retracted position,

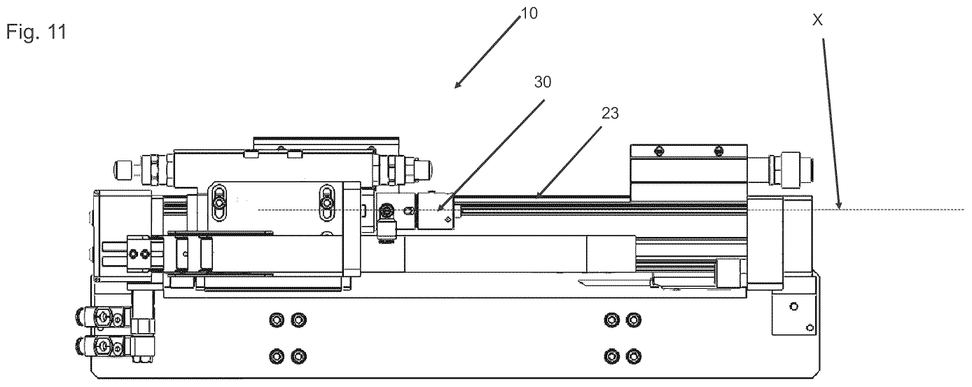

FIG. 11 Shows a Side View of the Device According to FIG. 10,

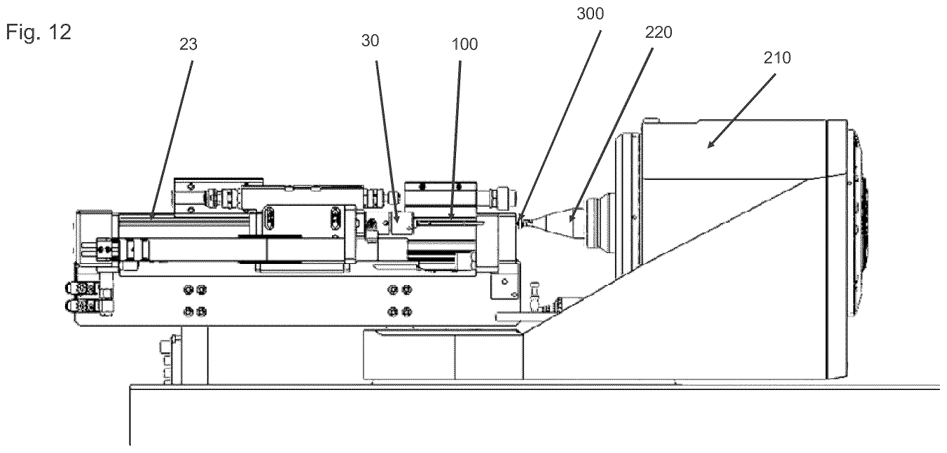

FIG. 12 shows a side view of the device with machine tool according to FIG. 8 with retracted clamping ram, and

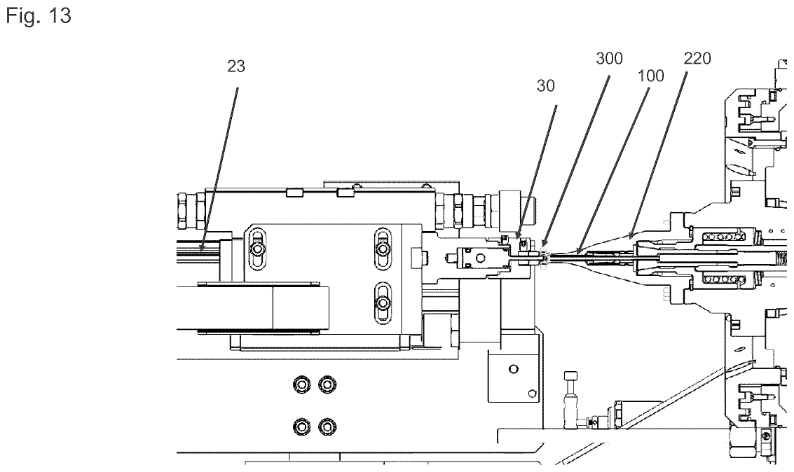

FIG. 13 shows a sectional view of the device with machine tool according to FIG. 12 with the clamping ram detached from the contact element.

FIG. 1 through FIG. 13 show various views of a device 10 for handling a clamping ram 100 as well as parts thereof and their arrangement relative to a machine tool 200.

The clamping ram 100, which can be recognized, in particular, in FIG. 4 and FIG. 6, comprises a cylindrical, elongate shaft 110 with a longitudinal axis L, a first end 110a and a second end 110b. The first end 110a can be rounded off or tapered. A collar 112 is arranged at the second end 110b, which collar in particular comprises a radial thickening and can, for example, be designed in the manner of a head of a screw or a nail. The ram 100 can comprise a recess 114 on a front side at the second end 110b, which ram, in particular, extends in an axial direction. The recess 114 can be rotationally symmetrical. The clamping ram 100 is usually made of metal.

The clamping ram 100 can be used to fasten a tool or workpiece 300 to a tool or workpiece holder 220 of a spindle or axis of rotation or an indexing head 210 of the machine tool 200. The tool or workpiece 300 comprises a through hole 310, through which the clamping ram 100 can be guided leading with the first end 110a until the collar 112, which has a larger outer diameter than the hole 310, bears against the tool or workpiece 300. The clamping ram 100 can be gripped and fixed in the tool or workpiece holder 220 by a corresponding gripping device, wherein a fixation under tension of the tool or workpiece 300 can be achieved, in particular, by pulling it into the tool or workpiece holder 220. The fact that the clamping ram 100 solely has the collar 112 or, in other words, a head in the manner of a screw or a nail at its second end 110a means that, if the hole 310 has a counterbore 312, a recessed arrangement of the collar 112 in the counterbore 312 can be achieved and thereby a protrusion of a part of the clamping ram 100 above the tool or workpiece 300 can be avoided.

The device 10 for handling the clamping ram 100 comprises an arm 20 (see, in particular, FIG. 8 through FIG. 13) which can be moved in at least one spatial direction X and which arm has a first end 20a, on which a fastening unit 30 (see, in particular, FIG. 1 through FIG. 7) for fastening the clamping ram 100 is arranged.

The fastening unit 30 comprises a magnetic or magnetizable contact element 31 for magnetically fastening the clamping ram 100. In the embodiment shown, the contact element 31 comprises a permanent magnet 32.

Alternatively or additionally, the contact element 31 may comprise an electromagnet (not shown).

The fastening element 30, in particular the contact element 31, can be arranged on a front side 22 of the arm 20a (see, for example, FIG. 9).

The contact element 31 can comprise an alignment tip 33 which, as can be seen in particular in FIG. 4 through FIG. 7, can be inserted into the recess 114 of the clamping ram 100. In particular, the alignment tip 33 projects beyond a contact surface 31a of the contact element 31 by such a length that the front side of the second end 110b of the clamping ram 100 bears against the contact surface 31a when the alignment tip 33 is inserted in the recess 114 of the clamping ram (see FIG. 4). In this way, the clamping ram 100 can be aligned, in particular such that the longitudinal axis L of the clamping ram is arranged substantially perpendicular to the contact surface 31a or such that the longitudinal axis L runs parallel to the spatial direction X.

The contact element 31 can comprise an ejector pin 34, which can be configured to be movable relative to the contact element 31, in particular, relative to the contact surface 31a. In the present embodiment example, the alignment tip 33 is arranged on the ejector pin 34. If the ejector pin 34 is extended out of the retracted position (see FIG. 4 and FIG. 5), in which the front side of the second end 110b of the clamping ram 100 bears against the contact surface 31a, into an extended position (see FIG. 6 and FIG. 7), the magnetic fixation between the clamping ram 100 and the contact element 31 is released. In particular, this allows the clamping ram 100, in particular, the collar 112 of the clamping ram 100, to be pressed into the counterbore 312 of the hole 310 of the tool or workpiece 300.

The ejector pin 34 can be arranged spring-loaded in a retracted position by the action of a spring 35 and can be moved into an extended position against the spring force of the spring 35. The extending of the ejector pin 34 can take place, for example, by means of a pneumatic unit 36. Compressed air can be supplied to the pneumatic unit 36 by means of an air connection 37 in order to move the ejector pin 34 into the extended position against the spring-loaded action of the spring 35.

The arm 20 is preferably movable in precisely one spatial direction X, for example along a linear axis 23. The movement of the arm 20 can be limited by a stop 24. The contact element 31 is arranged on the arm 20, in particular, in such a way that the longitudinal axis L of the clamping ram 100 attached to the fastening unit 30, in particular the contact element 31, is arranged parallel to this spatial direction X.

The arm 20 is preferably arranged relative to the machine tool 200 such that a rotational axis D of the spindle, of the axis of rotation or of the indexing head 210 is arranged parallel to the longitudinal axis L of the clamping ram 100 fastened to the fastening unit 30 and to the at least one, in particular precisely one, spatial direction X in which the arm 20 is movable.

A change of the tool or the workpiece 300 on the machine tool 200, wherein the tool or the workpiece 300 is held under tension in the tool or workpiece holder 220 by means of the clamping ram 100, can be carried out as follows:

The tool or workpiece 300 held under tension in the tool or workpiece holder 220 is gripped with a first handling unit. Subsequently, the arm 20 of the device 10 for handling the clamping ram 100 is moved in the spatial direction X until the contact element 31 of the fastening unit 30 bears against the clamping ram 100, in particular the front side at the second end 100b. The device 10 is thereby, in particular, positioned relative to the machine tool 200 in such a way that the arm 20 only needs to be advanced along the linear axis 23 in spatial direction X. The fastening of the clamping ram 100 to the unit 30 thereby takes place on the basis of the magnetic or magnetizable contact element 31 when the fastening unit 30 approaches the clamping ram 100.

If the clamping ram 100 is still fixed in the tool or workpiece holder 220, the fixation is released. Subsequently, the clamping ram 100 can then be pulled out by moving the arm 20 back in the spatial direction X until the clamping ram 100 is completely pulled out of the hole 310 of the tool or workpiece 300. The first handling unit thereby prevents the tool or workpiece 300 from falling out below. As soon as the clamping ram 100 is completely pulled out of the hole 310 of the tool or workpiece 300, the tool or workpiece 300 can be removed by means of the first handling unit and, in particular, deposited at a desired location. A new tool or workpiece 300 can now be supplied. This takes place either by means of the first handling unit, after it has deposited the tool or workpiece 300 to be changed, or advantageously, to shorten the changeover time, by means of a second handling unit, which can already move the new tool or workpiece 300 to the tool or workpiece holder 220 while the tool or workpiece 300 to be changed is being removed from the tool or workpiece holder 220 by means of the first handling unit. As soon as the new tool or workpiece 300 is positioned in front of the tool or workpiece holder 220, wherein, in particular, the hole 310 is aligned with the spatial direction X, the clamping ram 100 can be retracted by moving the arm 20 with the clamping ram 100 in the spatial direction X until the collar 112 of the clamping ram 100 bears against the new tool or workpiece 300. Subsequently, the ejector pin 34 can be extended, in particular, by activating the pneumatic unit 36, in order to release the clamping ram 100 from the fastening unit 30. The clamping ram 100 can be fixed in the tool or workpiece holder 220 and, in particular, pulled further into the tool or workpiece holder until the tool or workpiece 300 is fixed under tension. In particular, the collar 112 of the clamping ram 100 is recessed in the counterbore 312 of the tool or workpiece 300 in such a way that no part of the clamping ram 100 protrudes beyond the tool or workpiece 300.

The fact that the clamping ram 100 can be held magnetically fixed on its front side at the second end 100b makes it possible to change the tool or workpiece 300 simply by carrying out a linear movement of the clamping ram 100 along the spatial direction X.

### LIST OF REFERENCE SIGNS

10 device
20 arm
20a first end
22 front side
23 linear axis
24 stop
30 fastening unit
31 contact element
31a contact surface
32 permanent magnet
33 alignment tip
34 ejector pin
35 spring
36 pneumatic unit
37 air connection
100 clamping ram
110 shaft
110a first end
110b second end
112 collar
114 recess
200 machine tool
210 spindle, axis of rotation or indexing head
220 tool or workpiece holder
300 tool or workpiece
310 hole
312 counterbore
L longitudinal axis
X spatial direction
D rotational axis

1-16. (canceled)

17. Method for changing a tool or a workpiece (300) on a machine tool (200), wherein the tool or the workpiece (200) is held under tension in a tool or workpiece holder (220) by means of a clamping ram (100), comprising the following steps:
gripping the tool or workpiece (300) held under tension in the tool or workpiece holder (220) with a first handling unit,
moving the arm (20) of a device (10) for handling a clamping ram (100) in a spatial direction (X) until the contact element (31) of the fastening unit (30) bears against the clamping ram (100),
pulling out the clamping ram (100) by moving the arm (20) back in the spatial direction (X) until the clamping ram (100) is completely pulled out of the hole (310) of the tool or workpiece (200),
removing the tool or workpiece (300) by means of the first handling unit,
supplying of a new tool or workpiece (300),
retracting the clamping ram(100) by moving the arm (20) with the clamping ram (100) in the spatial direction until the collar (112) of the clamping ram (100) bears against the new tool or workpiece (300).

18. Method according to claim 17,
characterized in that the arm (20) is moved in precisely one spatial direction (X).

19. Method according to claim 17,
characterized in that the supplying of the new tool or workpiece (300) takes place using a second handling unit.

20. Method according to claim 17,
characterized in that, before the clamping ram (100) is pulled out, the fastening of the clamping ram (100) in the tool or workpiece holder (220) is released and, after the clamping ram (100) is retracted, the clamping ram (100) is refastened in the tool or workpiece holder (220).

21. Method according to claim 17,
characterized in that an ejector pin (34) of the device (10) is advanced after the clamping ram (100) has been retracted in order to release the clamping ram (100) from the device (10).
